(19) United States
(12) Patent Application Publication
(10) Pub. No.: US 2022/0153049 A1
(43) Pub. Date: May 19, 2022

(54) METHOD FOR APPLYING A MARKING ON AN OBJECT AND MARKING APPARATUS

(71) Applicant: ALLTEC ANGEWANDTE LASERLICHT TECHNOLOGIE GMBH, Selmsdort (DE)

(72) Inventor: Peter J. Kueckendahl, Bad Oldesloe (DE)

(21) Appl. No.: 17/441,216

(22) PCT Filed: Jan. 13, 2020
(86) PCT No.: PCT/EP2020/050703

§ 371 Date: Sep. 20, 2021

(30) Foreign Application Priority Data
Mar. 20, 2019 (EP) 19164135.6

(51) Int. Cl. B41M 5/26; B41M 5/24; B41M 5/48

(52) U.S. Cl. CPC B41M 5/262; B41M 5/48; B41M 5/24

(57) ABSTRACT

The invention relates to a method for applying a marking within a marking area on an object, in which at least one light beam is emitted with light emitting means, scanning means are moved to deflect the light beam line by line over the marking area, while the light emitting means is switched between being activated or deactivated according to the marking to be applied. The method is characterized in that, for each start of a line movement of the light beam over the object, the scanning means is moved such that its deflection direction points at a line starting point outside the marking area and the scanning means is accelerated such that its deflection direction is accelerated from the line starting point towards the marking area, wherein the light emitting means is deactivated while the deflection direction points somewhere outside the marking area. The invention further relates to a corresponding marking apparatus.

The present invention relates in a first aspect to a method for applying a marking on an object according to the preamble of claim 1. In a second aspect, the invention relates to a marking apparatus according the preamble of claim 13.

Marking apparatuses commonly use light beams to apply, i.e. produce, markings on objects. These objects may in principle be any kind of articles, such as food, beverages or packages, and may comprise a variety of different materials.

The marking itself may in general form any kind of sign, character, text, picture, bar code, and in particular a 2D matrix code such as an ID matrix or QR code.

A light beam used to produce the marking is in many cases controlled as a vector laser, i.e., the light beam is variably deflected or scanned over the object to form the marking.

During such a marking process, vibrations and shocks will lead to distortions in the marking and thus reduce readability. A potential counter measure is to increase the marking in size or to increase the error correction level, which in turn leads to a larger marking.

However, as time demand to produce a marking is at a premium, an increase in size of the marking and the entailed time increase are often prohibited.

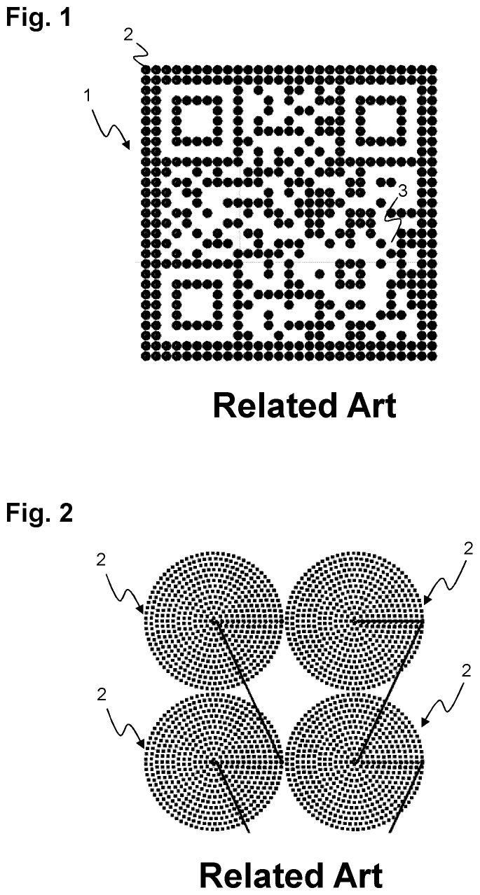

A related art method for producing a marking will be explained with reference to FIG. 1. FIG. 1 shows a marking 1 produced on an object. The marking 1 is a 2D code 1 and comprises several cells containing a mark 2 and several cells 3 without a mark, according to an image to be marked. Each cell 2, 3 corresponds to one pixel of the image.

The marks 2 are produced by illuminating the respective regions of an object with a light beam. However, one mark 2 is not merely a spot or dot, but consists of many dots created by the light beam, as shown enlarged in FIG. 2. The light beam is emitted as a pulsed beam and moved spirally to produce a spiral dot pattern 2 as one mark 2.

When the printing of one mark 2 is concluded, a direction in which the light beam would be directed when activated is moved to a next cell in which a next spiral mark 2 is to be produced, as shown with a bold line in FIG. 2. The technique thus forms a cell-by-cell rendering.

This approach is prone to adverse vibrational impacts. A short vibration affects the dots forming one mark 2 to be shifted relative to the other marks 2, thus distorting the marking 1. Furthermore, the spiral movement hampers improvements in time demand for producing the marking 1.

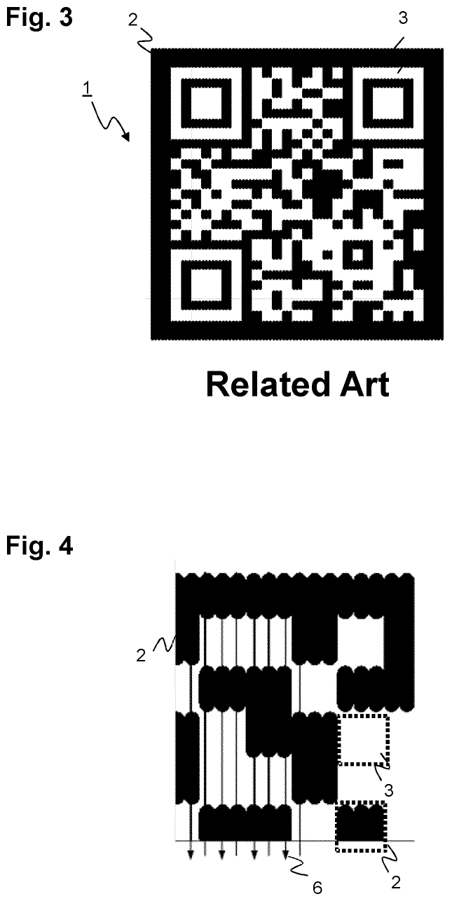

Another related art method, on which the invention is grounded, will be later described with reference to FIG. 3.

In such a generic method for applying a marking within a marking area on an object, at least one light beam is emitted with light emitting means, and scanning means are moved to deflect the light beam line by line over the marking area, while the light emitting means is switched between being activated or deactivated according to the marking to be applied.

A conventional marking apparatus for applying a marking within a marking area on an object comprises:
light emitting means for emitting at least one light beam used for marking,
scanning means for deflecting the light beam, and
control means for moving the scanning means to deflect the light beam line by line over the marking area while switching the light emitting means between being activated or deactivated according to the marking to be applied.

FIG. 3 shows a marking 1 produced with such a marking apparatus. Again, the marking 1 comprises filled cells 2 and blank cells 3. However, a mark 2 in a cell is not produced by moving the beam spirally. Instead, the light beam is scanned line by line over a marking area, in the drawing from top to bottom, then in a neighbouring line/column from bottom to top and so forth.

In these generic techniques, one or more light beams are scanned over the object to produce the marking. It is desirable to move a light beam as fast as possible without unduly affecting the print quality.

In the prior art, one attempt to increase scanning speed of a light beam resides in increasing the scanning speed of the scanning means for time periods when the light emitting means are deactivated, i.e., when the scanning means point at an area or cell of the object that is to be left blank. However, after such an increased velocity movement, which is also referred to as a jump, the scanning means not only have to be decelerated, but a waiting time has to elapse, in particular to avoid undesired vibrations of the scanning means. While a long jump indeed reduces marking time, the benefit of a short jump may be overcompensated by the waiting times, leading to an overall increased time demand.

It is an object of the invention to provide a method for applying a marking on an object and a marking apparatus that are particularly fast in producing a marking without compromising the marking quality.

This object is solved by a method having the features of claim 1 and a marking apparatus as described in claim 13.

Preferred embodiments are given in the dependent claims as well as in the following description, in particular in connection with the attached figures.

The method of the above mentioned kind is, according to the invention, characterized in that for each start of a line movement of the light beam over the object,
the scanning means is moved such that its deflection direction points at a line starting point outside the marking area, and
the scanning means is accelerated such that its deflection direction is accelerated from the line starting point towards the marking area,
   wherein the light emitting means is deactivated while the deflection direction points somewhere outside the marking area.

According to the invention, the marking apparatus of the above mentioned kind is characterized in that the control means is adapted
to move the scanning means, for each start of a line movement of the light beam over the object, such that a deflection direction of the scanning means points at a line starting point outside the marking area and
to accelerate the scanning means such that its deflection direction is accelerated from the line starting point towards the marking area, and
to deactivate the light emitting means while the deflection direction points somewhere outside the marking area.

It can be regarded as a core idea of the invention to introduce an acceleration phase of the scanning means prior to commencing the actual marking process. In this way, a comparably high speed is already reached when the light emitting means are turned on. Advantageously and in contrast to the prior art, significant changes of the scanning speed during the emission of a light beam do not occur. This facilitates the marking process and reduces the susceptibility to distortions or inaccuracies in the produced marking.

The pointing or deflection direction of the scanning means defines an impinging spot on the object at which a light beam can be directed. It is a fundamental basis of the invention that, during the marking process, the deflection direction does not always point at a region within the marking area, i.e. within an area in which the marking is to be produced. In contrast, for each line movement, the deflection direction starts at a line starting point outside the marking area, then moves through the marking area and leaves the marking area on the opposite side for continuing to the next line movement.

When the deflection direction points somewhere outside the marking area, it points at a region between the line starting point and the marking area or at a region which prolongs the line movement after leaving the marking area. These time periods are used for accelerating and decelerating the scanning means without impairing a mark produced with the light beam which would occur in prior art techniques that employ significant speed variation while the light beam is emitted.

Full advantages are achieved if the deflection direction is moved by the scanning means with a constant speed throughout the whole marking area. Accelerations and decelerations thus occur exclusively outside the marking area. In particular, no speed changes occur during the line movement within the marking area, independent of whether parts of the line are to be left blank or are to be filled with a mark. This avoids any waiting times required in the prior art. Furthermore, the advantages of the line starting point outside the marking area are not attenuated by introducing any speed changes within the marking area.

The marking area may be understood as that part of the object in which a marking is to be produced. It can be comprehended to be a polygonal, in particular rectangular area, or in mathematical terms, a simply connected space (i.e. an area without holes). Its edges or borders are determined by the outermost marks to be produced.

The produced marks together form the desired marking, which may be a black and white or two colour image. Alternatively, shades of grey or different colors may be produced via the light beam(s).

The activation and deactivation of the light emitting means may be understood as whether or not a light beam is transmitted onto the object via the scanning means and used to produce the marking. Hence, a deactivation may also comprise the case that the light emitting means output continuously a light beam which is then blocked or directed somewhere else where it is not used to produce the afore-referenced marking.

In general, the scanning means may be any means that can be moved to alter a deflection direction. To this end, the scanning means may comprise one or more movable deflection elements such as mirrors or lenses, or one or more optical fibers that are translationally moved or rotated to adjust the deflection direction. Preferably, the scanning means comprise at least two deflection elements which can be rotated about different axes, wherein a light beam is directed from one of the deflection elements to the other and further in the direction of the object. The two deflection elements are preferably galvanometer scanning mirrors and are jointly controlled to create the line by line movement.

The expression that a light beam is directed from the scanning means to the object does not exclude that the light beam may be guided via further optical elements between the scanning means and the object.

The at least one light beam may be of any kind as long as it is suited to manipulate the object. Depending on the kind of object, in particular its material, different wavelengths and/or light intensities may be suitable. For marking a variety of different objects, the light emitting means may comprise several light units that emit light with different wavelengths and/or intensities. These light beams may be directed onto a common beam path and further to the scanning means. Alternatively or additionally, several light beams may simultaneously be used for producing marks on different areas, or on a common spot on the object for increased light intensity, which may be used for producing different shades of colour or grey levels.

For a focused high intensity beam, the light emitting means may comprise at least one laser. The laser may be a continuous wave laser or a pulsed laser. In the latter case, several dots that may or may not overlap each other are formed during a line movement. Preferably, however, a line mark without interruptions is formed by a continuous wave laser.

The constant speed of the deflection direction may be defined by a constant velocity of one of several components or properties: First, the deflection direction of the scanning means defines an impinging spot on the object. If the light emitting means are activated, the light beam is directed onto that impinging spot. By moving the scanning means, the impinging spot is moved over the object. The movement of the deflection direction as described herein may be understood as the movement of the impinging spot. The constant speed may be regarded as the speed of the impinging spot movement. Alternatively, the constant speed may refer to a constant speed of the scanning means, in particular a constant rotational speed. This facilitates technical implementations. A constant speed of the movement of the deflection direction may thus also be understood as a constant rotational speed of the movement of the deflection direction.

The line by line movement of the light beam over the marking area is to be understood such that the impinging spot, onto which the scanning means point, is moved over the object one line after the other, i.e. in a (preferably straight) line movement, followed by a displaced next line movement, and so forth. Each line movement is not restricted to the marking area but extends over it, from the line starting point until a next line starting point which in generally on the opposite site of the marking area.

For each line movement of the deflection direction, it may be accelerated from the respective line starting point until the start of the marking area, from where the deflection direction is further moved with a constant speed. That is, the constant speed may be reached directly upon entering the marking area. Unnecessary long acceleration paths are thus avoided. Alternatively, the constant speed may be reached slightly prior to entering the marking area in order to ensure that a desired speed, without harmful speed variations, is set upon reaching the marking area. This slight distance is preferably smaller than a third, preferably a fourth, of the length from the line starting point to the marking area.

To avoid disturbing speed variations of the deflection direction's movement, i.e. of the movement of the impinging spot over the object, an acceleration of the deflection direction's movement may become smaller while the deflection direction moves from the line starting point to the marking area.

A raw image, which the marking is supposed to reflect, generally comprises pixels arranged in lines and columns. Each line of the raw image may be translated to one line of the marking, which leads to a short marking time. However, for increased image quality and resistance against vibrations, it is preferred that one raw image line is represented by several neighboring lines of the line by line movement of the deflection direction.

The raw image or raw image data may generally be any kind of information that can be processed by the marking apparatus to a pattern that is then reproduced as the marking. The raw image may thus be, e.g., a digital image file on a pixel or vector basis and/or text information.

Preferably, several image line vectors are derived from raw image data, wherein each image line vector is constituted of a string of first pixel values for which the light emitting means are activated and second pixel values for which the light emitting means are deactivated. A sequence of first pixel values leads to a line mark, for instance, whereas altering first and second pixel values lead to a dotted line mark. Each image line vector may correspond to another line of the raw image, or a number of image line vectors may correspond to one and the same line of the raw image, in which case the number of line marks is a multiple of the number of raw image lines.

The movement of the scanning means is determined via the lengths and number of the image line vectors. That is, the longer the image line vector, the greater the scanning means movement, e.g. its maximum rotational angle.

For controlling the scanning means to move its deflection direction not merely over the marking area but to start at the respective line starting point, a dummy vector may be added to the image line vector, the dummy vector being constituted of only second pixel values, i.e., pixel values for which no light beam is emitted. This procedure facilitates a technical retrofit of prior art marking apparatuses, as the software and hardware structure of prior art marking apparatuses can be maintained to a considerable degree.

In order to quickly scan the whole marking area, directly neighboring lines of the line by line movement of the deflection direction preferably have an antiparallel movement direction.

The acceleration of the deflection direction from the line starting point to the marking area may lead to a mark for the respective line being shifted towards its respective line starting point. This may be understood as follows: Each image pixel or entry in an image line vector corresponds to a distinct region or cell on the object. All cells should have the same size to avoid distortions and line displacements. However, if the scanning means is accelerated while pointing at one cell, this poses the problem of a cell being smaller than a cell for which the scanning means have already reached the final constant speed. As neighboring lines are scanned in antiparallel directions, a displacement between directly neighboring lines may thus occur. This displacement is in the line direction. For compensating the displacement, every second line is preferably displaced by a common adjustable amount. Such a compensating displacement may be achieved by shifting all image line vectors with an even number relative to the image line vectors with an odd number. This is tantamount to setting the line starting points on the object such that smaller cells are assigned to the dummy vector entries (which correspond to the acceleration phase) than to the remaining image line vector entries (which correspond to the marking to be produced within the marking area).

For determining a value for the common adjustable amount, the following steps may be carried out: a reference marking is produced; then the reference marking is analyzed to determine the displacement between directly neighboring lines; after which the common adjustable amount is set dependent on the determined displacement. An iterative process may be applied in which a second reference marking is produced with the set common adjustable amount, and dependent on a displacement that may still be present the common adjustable amount is again amended. The determination of the displacement may be carried out manually, or preferably automatically with optical recording means that detect the reference marking(s), e.g. with one or more cameras.

A transverse movement of the deflection direction is necessary for shifting to a next line, in order to execute the line by line movement. The transverse movement is thus transverse to the line movement. Preferably, the transverse movement is carried out during an acceleration phase of the deflection direction between the line starting point and the beginning of the marking area, and/or during a deceleration phase after leaving the marking area. By overlaying the transverse movement with the acceleration and/or deceleration phase of a line movement, substantially no extra time is required for shifting to a next line. This leads to a straight line movement of the deflection direction while pointing somewhere inside the marking area and a bend or curved movement during a deceleration and/or acceleration phase in which the deflection direction points somewhere outside the marking area. It may be preferred to superimpose the transverse movement with both the acceleration and deceleration phase in order to use as much time as possible to precisely execute the transverse movement. Alternatively, only the deceleration phase may be used for the transverse movement to avoid any interfering impact on the movement during the acceleration phase, which is crucial for reaching the marking area with the desired speed and with preferably low line displacements, as explained above.

Dependent on a raw image to be marked, some raw image lines may start with a first pixel value for which the light emitting means are to be activated, and others start with a second pixel value for which the light emitting means are to be deactivated. It follows that some lines within the marking area start with a region to be left blank (corresponding to a second pixel value), and other lines within the marking area start with a region to be marked (corresponding to a first pixel value). If one line starts with an unmarked region, this region can also be used for the acceleration phase that starts from the respective line starting point. In other words, the line starting points of different lines can be determined as one fixed distance before a first region to be marked within the marking area, wherein the first region corresponds to a 1^{st} first pixel value of that line. The line starting points thus have different positions in the line movement direction dependent on the position of the 1^{st} first pixel value of that line.

In the above variant, a border of the marking area may be understood as being defined by the 1^{st} first pixel value of each line. If the lines are scanned alternately from left and from right, then the 1^{st} first pixel values of the lines are also counted alternately from left or from right.

The descriptions of the movements of the deflection direction of the scanning means shall be understood relative to the object. If the object moves, e.g. on a conveyor belt, this movement is superimposed on the movements described herein. In particular, the line by line movement of the deflection direction of the scanning means may be supplemented with an additional movement of the scanning means to account for an advance of the object.

The inventive concept for increased marking speed is suited for an inventive variant in which several light beams are emitted and used to produce simultaneously different parts of the same marking. The light beams may be directed displaced to each other, in particular parallel to each other, onto the same scanning means. Hence, several line movements can be performed simultaneously. Using the same scanning means avoids any undesired time or length offsets. The beams may be emitted from several light emitting means that can be activated independently from each other. In this way, the beams can produce independent line marks on the object, i.e. non-identical line marks. This preserves a good resistance against vibrational interference. Alternatively, the beams are emitted from one and the same light emitting means or a number of light emitting means that are jointly activated or deactivated. This variant is suitable if several line movements are required for one image data line, i.e. if several neighbouring line marks correspond to one pixel line of the image data. In this case, no independent movement of the beams is required. For a particularly good image quality, the light beams may be guided such that their impinging spots on the object touch each other.

If a plurality a light beams is directed onto the scanning means, its described deflection direction and impinging spot may be understood as one deflection direction per light beam and one impinging spot per light beam.

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 shows a marking produced with a related art method;

FIG. 2 shows an enlarged portion of FIG. 1;

FIG. 3 shows a further marking;

FIG. 4 shows a detail of FIG. 3;

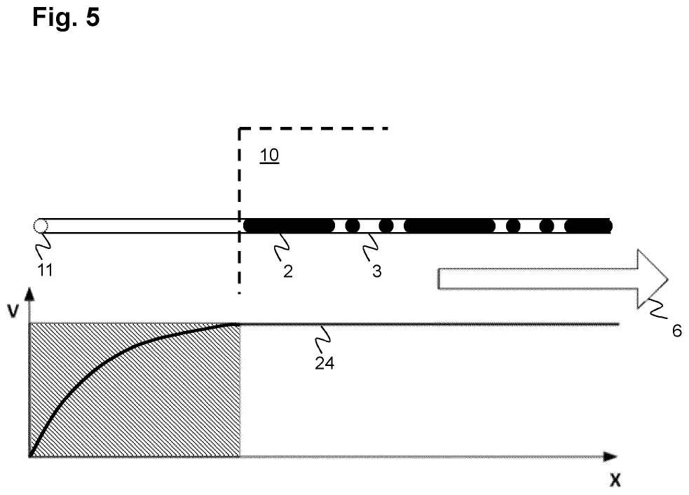

FIG. 5 shows a diagram of how to move a light beam with scanning means, for illumination a part of the inventive marking method and apparatus;

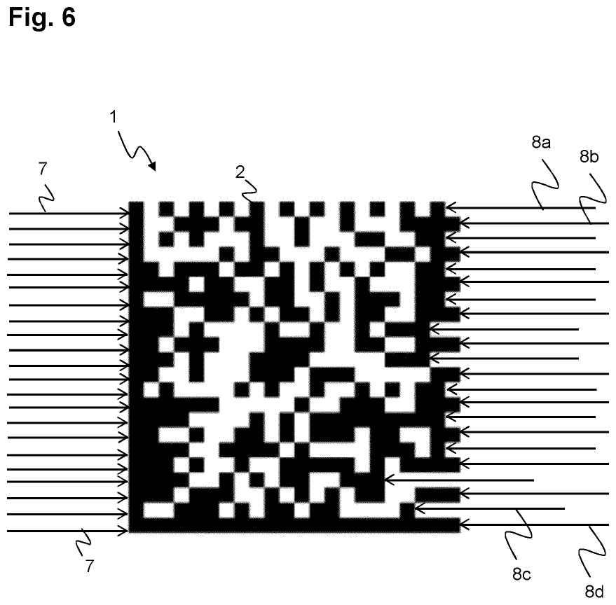

FIG. 6 shows an explanatory diagram of a marking to be produced;

FIG. 7 shows a sequence of method steps of an embodiment of an inventive method;

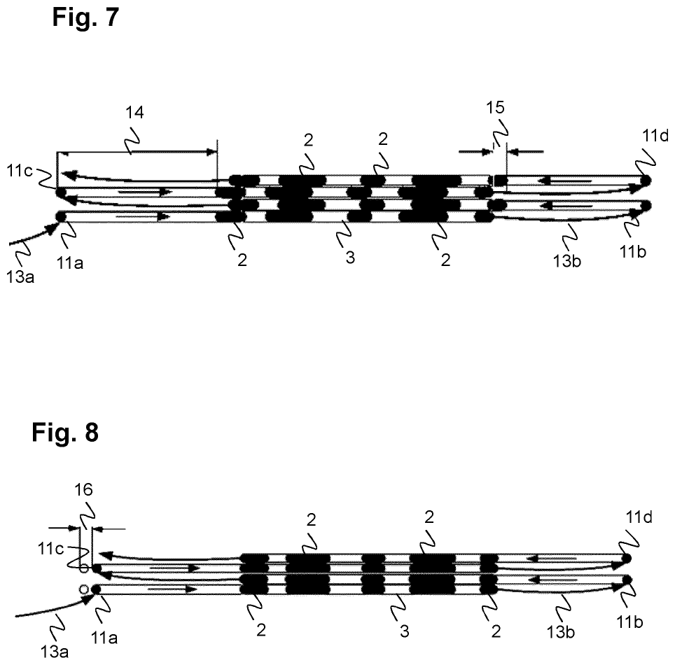

FIG. 8 shows a sequence of method steps of another embodiment of an inventive method; and

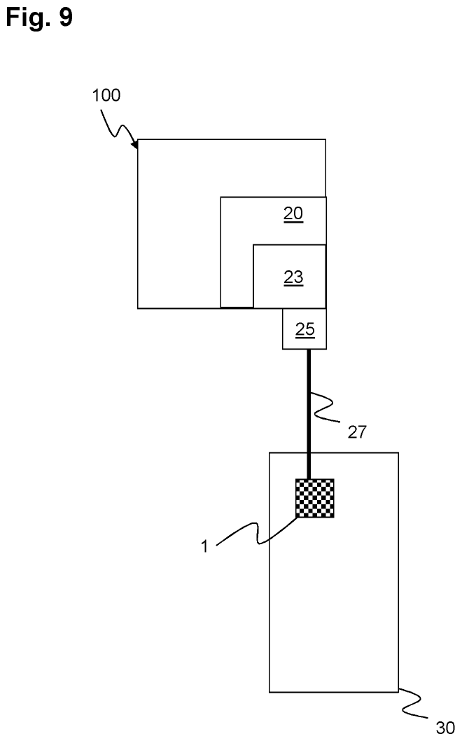

FIG. 9 shows an embodiment of an inventive apparatus.

A related art marking method is shown in FIGS. 1 and 2. This method is described in the introductory portion of this application and shows several disadvantages compared to the method of the invention: First, the marking method of FIGS. 1 and 2 is not capable of very high marking speeds. Furthermore, a vibration of e.g. the object leads to a shift of the marking part that is produced during the vibration relative to the remaining marking parts, deteriorating readability.

A generic marking method uses a line by line scanning sequence which leads to the marking shown in FIG. 3. This marking is described in the introductory part and can be produced either with an inventive or a related art method.

A detail of FIG. 3 in shown in FIG. 4 for explanation of an embodiment of the inventive marking method. Each pixel of an image or raw image to be marked corresponds in position to one cell 2, 3 within a marking area on the object. A mark in one cell 2 is here not produced by moving the light beam once over that cell 2. Rather, several line movements 6 of the light beam cross one cell 2. In the depicted example, three line movements 6 lead through each cell 2, 3. Light beams with small cross sections can thus be used. This improves image quality, and, as light intensity is not equally distributed throughout the light beam cross section, multiple small cross section lines avoid one large beam with a problematically high light intensity at its centre.

To minimize the required marking time, consecutive lines are scanned in antiparallel directions, as shown with the arrows 6.

A main aspect of the invention resides in the control of scanning means for deflecting the light beam. This movement is best described with an impinging spot, i.e., an area on the object onto which a light beam is or would be deflected with the scanning means. The impinging spot is moved via the scanning means over the object.

For producing the single marks that make up the marking, prior art methods merely move the impinging spot within the marking area, i.e. from one region where a mark is to be created to the next region where a mark is to be created.

In contrast, the inventive method demands the impinging spot to be moved outside the marking area. This leaves room for accelerating the scanning means before the marking process begins. From then on, a constant speed of the scanning means can be deployed. Overall, this reduces the required marking time.

This concept will be further described with reference to FIG. 5. The upper part of this figure shows the beginning of one line movement of the impinging spot, i.e. the deflection direction of the scanning means. Below the speed with which the impinging spot is scanned over the object is shown.

The marking process starts with moving the impinging spot to a line starting point 11, shown as a dotted circle in FIG. 5. From there, the scanning means is accelerated, leading to an accelerating movement of the impinging spot in the direction 6. The line starting point 11 is chosen at a position outside a marking area 10 in which the marking is to be produced. The acceleration of the impinging spot movement ends upon reaching the marking area 10, as shown with the speed function 24 which is depicted in a diagram of speed v against the space coordinate x in the lower part of FIG. 5.

The light emitting means is deactivated while the impinging spot is outside the marking area 10.

During the line movement within the marking area 10, the light emitting means are alternatingly activated and deactivated, according to image data. In this way, several marks 2 separated by blank regions 3 are formed. Within the marking area 10, the impinging spot is moved with a constant speed, as shown by the speed function 24. In this way, no waiting times after a jump, i.e. after passing over a blank region 3, are required, and hence time can be saved as compared with prior art techniques.

The line starting point 11 is chosen as a fixed distance in front of the marking area 10. This distance should not be too large as this would again lead to an increase in time demand. It is preferable that the line starting point 11 is set dependent on the position of a first pixel in one line which requires the light emitting means to be turned on. This will be illuminated with reference to FIG. 6.

FIG. 6 shows a marking 1 as well as arrows 7, 8a, 8b, 8c and 8d which indicate the line movement outside the marking area. A scanning or line movement direction is alternatingly from left to right and from right to left. Note that each image line corresponds to several neighbouring line marks, e.g. a lowest image line corresponds to a first line movement from left to right, followed by a movement from right to left according to the arrow 8d, which jointly produce the depicted sequence of filled cells 2.

A line starting point is indicated in FIG. 6 as the beginning of a respective arrow 7 and 8a to 8d. On the left side of the marking 1, the first cell 2 to be filled, i.e. the first mark in each cell, is located at the same position with regard to the line movement direction. Consequently, all line starting points on the left side are at the same position with regard to the line movement direction. In contrast, on the right side of the marking 1, the first cell 2 to be filled varies with different lines. The line starting points on the right side are chosen accordingly: The arrows 8a to 8d start at different positions in the line movement direction, such that a common distance is formed from a line starting point to its respective first cell 2 to be filled in the respective line.

A problem related with the introduction of the inventive acceleration phase as well as its solution according to a variant of the invention will be described with reference to FIGS. 7 and 8.

FIG. 7 shows several line movements of the deflection direction of the scanning means as well as the marks 2 thus produced. To begin the marking process, the deflection direction, i.e. the impinging spot onto which the deflection direction points, is moved to the line starting point 11a, as indicated with arrow 13a. From here, the impinging spot is accelerated towards the marking area, then the light emitting means are activated several times to form marks 2, and when the end of the marking area is reached, the impinging spot is decelerated and moved to a line starting point 11b of a next line, as indicated with arrow 13b.

From the line starting point 11b, a procedure similar to the one explained above follows; the difference being that this line is scanned from right to left instead of left to right. These directions should be understood as merely being opposite each other, and are thus equivalent to a “top to bottom direction” or any differently orientated pair of antiparallel movements.

The scanning movement continues after the second line to the line starting point 11c of the third line, and so forth.

The position of the line starting points 11a to 11d can be expressed via dummy vectors that are added to image data line vectors according to which one line of the marking 1 is to be produced. The length of a dummy vector influences the distance 14 from a line starting point to the marking area.

The movement of the impinging spot during the acceleration phase of each line is comparably slow. Without counter measures being taken, this leads to the entries of the dummy vector being translated to smaller distances on the object than the entries of the image data line vectors which encode the image to be marked. The marks 2 of each line are thus displaced towards the line starting point 11a to 11d of the respective line. This leads to a displacement 15 between marks 2 of lines that are scanned from right, and marks 2 of lines that are scanned from left.

The displacement 15 constitutes a distortion of the marking 1 and should be compensated. This is achieved with an embodiment of the invention that will be described with reference to FIG. 8.

FIG. 8 differs from FIG. 7 in that a compensating displacement 16 is added to all line movements that start from the left side. That is, the line starting points 11a and 11c do not start at the positions of FIG. 7 (indicated in FIG. 8 by hollow circles) but at a position displaced in the line movement direction by a common amount. Depending on the technical implementation, this may be achieved with a different length of a dummy vector for lines scanned from left compared to lines scanned from right.

Naturally, a compensating displacement may instead or additionally be applied to the lines scanned from right.

A marking apparatus 100 for carrying out the described method is shown in FIG. 9. The marking apparatus 100 comprises light emitting means 23, such as one or more lasers, for emitting one or more light beams 27, scanning means 25 to variably deflect the light beam 27, and electronic control means 20 to control the light emission and deflection. The light beam 1 is guided onto a surface of an object 30 to produce a marking 1.

The control means 20 are adapted to automatically execute the above-described method after input of image data or other print instructions.

In this way, a marking can be produced particularly fast without affecting the marking quality.

1. A method for applying a marking (1) within a marking area (10) on an object (30), in which
at least one light beam (27) is emitted with light emitting means (23),
scanning means (25) are moved to deflect the light beam (27) line by line over the marking area (10), while the light emitting means (23) is switched between being activated or deactivated according to the marking (1) to be applied,
characterized in that
for each start of a line movement of the light beam (27) over the object (30),
the scanning means (25) is moved such that its deflection direction points at a line starting point (11) outside the marking area (10) and
the scanning means (25) is accelerated such that its deflection direction is accelerated from the line starting point (11) towards the marking area (10),
wherein the light emitting means (23) is deactivated while the deflection direction points somewhere outside the marking area (10).

2. The method according to claim 1,
characterized in that
the deflection direction is moved with the scanning means (25) with a constant speed within the marking area (10).

3. The method according to claim 2,
characterized in that
the constant speed of the deflection direction is set by a constant rotational speed of the scanning means (25).

4. The method according to claim 1,
characterized in that
for each line movement of the deflection direction, it is accelerated from the respective line starting point (11) until the start of marking area (10), from where the deflection direction is further moved with a constant speed.

5. The method according to claim 1,
characterized in that
an acceleration of a movement of the deflection direction becomes smaller while the deflection direction moves from the line starting point (11) to the marking area (10).

6. The method according to claim 1,
characterized in that
one raw image line to be marked is represented by several neighboring lines of the line by line movement of the deflection direction.

7. The method according to claim 1,
characterized in that
from raw image data, several image line vectors are derived, each image line vector being constituted of a string of first pixel values for which the light emitting means (23) are activated and second pixel values for which the light emitting means (23) are deactivated, the movement of the scanning means (25) is determined via the lengths and number of the image line vectors,
for controlling the scanning means (25) to move its deflection direction not merely over the marking area but to start at the respective line starting point (11), a dummy vector is added to the image line vector,
the dummy vector being constituted of only second pixel values.

8. The method according to claim 1,
characterized in that
in the line by line movement of the deflection direction, directly neighboring lines have antiparallel movement directions,
for compensating a displacement between directly neighboring lines due to the acceleration of the deflection direction leading to a mark for the respective line being shifted towards its respective line starting point, every second line is displaced by a common adjustable amount.

9. The method according to claim 8,
characterized in that
for determining a value for the common adjustable amount, the following steps are carried out:
a reference marking is produced,
the reference marking is analyzed to determine the displacement between directly neighboring lines,
the common adjustable amount is set dependent on the determined displacement.

10. The method according to claim 1,
characterized in that
a transverse movement of the deflection direction for shifting to a next line is carried out during an acceleration phase of the deflection direction between the line starting point (11) and the beginning of the marking area (10), and/or during a deceleration phase after leaving the marking area (10).

11. The method according to claim 1,
characterized in that
a plurality of light beams is directed simultaneously onto the scanning means (25) to simultaneously produce several line marks.

12. The method according to claim 1,
characterized in that
dependent on a raw image to be marked, some raw image lines start with a first pixel value for which the light emitting means are to be activated, and others start with a second pixel value for which the light emitting means are to be deactivated, leading to some lines within the marking area (10) starting with an unmarked region (3) corresponding to a second pixel value, and other lines within the marking area starting with a marked region (2) corresponding to a first pixel value,
the line starting points (11) of different lines are determined as one fixed distance before a first region to be marked (2) within the marking area (11), the first region (2) corresponding to a 1^{st} first pixel value of that line, leading to the line starting points (11) having different positions with regard to a line movement direction dependent on the position of the 1^{st} first pixel value of that line.

13. A marking apparatus for applying a marking (1) within a marking area (10) on an object (30), comprising
light emitting means (23) for emitting at least one light beam (27) used for marking,
scanning means (25) for deflecting the light beam (27),
control means (20) for moving the scanning means (25) to deflect the light beam (27) line by line over the marking area (10) while switching the light emitting means (23) between being activated or deactivated according to the marking (10) to be applied,
characterized in that
the control means (20) is adapted
to move the scanning means (25), for each start of a line movement of the light beam (27) over the object (30), such that a deflection direction of the scanning means (25) points at a line starting point (11) outside the marking area (10) and
to accelerate the scanning means (25) such that its deflection direction is accelerated from the line starting point (11) towards the marking area (10), and
to deactivate the light emitting means (23) while the deflection direction points somewhere outside the marking area (10).

14. The marking apparatus according to claim 13,
characterized in that
the scanning means (25) comprise at least two deflection elements, in particular mirrors, that can be rotated about different axes, and
the two deflection elements are jointly controlled to create the line by line movement.
